(19) United States
(12) Patent Application Publication
(10) Pub. No.: US 2024/0179586 A1
(43) Pub. Date: May 30, 2024

(54) APPLICATION TIME FOR MOBILITY ENHANCEMENTS IN WIRELESS COMMUNICATIONS

(71) Applicant: ZTE Corporation, Shenzhen (CN)

(72) Inventors: Ling YANG, Shenzhen (CN); Bo GAO, Shenzhen (CN); Zhaohua LU, Shenzhen (CN); Shujuan ZHANG, Shenzhen (CN); Ke YAO, Shenzhen (CN); Yang ZHANG, Shenzhen (CN)

(21) Appl. No.: 18/529,788

(22) Filed: Dec. 5, 2023

Related U.S. Application Data
(63) Continuation of application No. PCT/CN2022/113987, filed on Aug. 22, 2022.

(51) Int. Cl. H04W 36/00; H04L 5/00

(52) U.S. Cl. CPC H04W 36/00692; H04L 5/0035; H04W 36/0072

(57) ABSTRACT

A wireless communication method includes receiving, by a communication device, a signaling that includes information to be used for one or more of: a handover of the communication device from a serving cell to a target cell or a candidate cell, or a communication between the communication device and the target cell or the candidate cell; and performing, by the communication device, an operation using the information.

### CROSS-REFERENCE TO RELATED APPLICATIONS

This application is a continuation of International Patent Application No. PCT/CN2022/113987, filed on Aug. 22, 2022, the contents of which are incorporated herein by reference in their entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for identifying a time domain location (e.g., time slot) where a user equipment (UE) can perform operations related to mobility from a source cell to a target cell.

In one example aspect, a method of wireless communication is disclosed. The method includes receiving, by a communication device, a signaling that includes information to be used for one or more of: a handover of the communication device from a serving cell to a target cell or a candidate cell, or a communication between the communication device and the target cell or the candidate cell and performing, by the communication device, an operation using the information.

In another example aspect, another method of wireless communication is disclosed. The method includes transmitting a signaling that includes information to be used for one or more of: a handover of the communication device from a serving cell to a target cell or a candidate cell, or a communication between the communication device and the target cell or the candidate cell.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1A shows an example of application time for transmission configuration indication (TCI) state indication disclosed in the present document.

FIG. 1B shows multiple examples of application times for a user equipment to apply a switching command or TCI state indication for L1/L2 mobility scenarios.

FIG.2A shows an example of a location of an acknowledge corresponding to switching command that is determined by an offset value after a starting of a slot where a switching command is received from target cell.

FIG.2B shows an example of a location of acknowledge corresponding to switching command that is determined by an offset value after the ending of slot where a switching command is received from target cell.

FIG. 3 shows an exemplary flowchart for wireless communication.

FIG. 4 shows an exemplary flowchart for wireless communication.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

### DETAILED DESCRIPTION

This patent document describes application time related techniques for information in L1/L2 mobility enhancements. The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### Introduction

When a wireless device such as a user equipment (UE) moves from the coverage area of one cell to another cell, at some point a serving cell change needs to be performed. Currently, serving cell change is triggered by L3 measurements and is done by radio resource control (RRC) signaling triggered Reconfiguration with Synchronization for change of primary cell (PCell) and primary and secondary cell (PSCell), as well as release add for secondary cells (SCells) when applicable. These cases can involve complete L2 (and L1) resets, leading to longer latency, larger overhead and/or longer interruption time than beam switch mobility. One of the goals of L1/L2 mobility enhancements is to enable a serving cell change via L1/L2 signaling, in order to reduce the latency, overhead and interruption time.

Current technology needs improvement to achieve a fast change of the serving cell via L1/L2 signaling, in order to reduce the latency, overhead and/or interruption time. Example techniques for such improvement may include adjusting or defining application time of an information, such as one or more of switching command, TCI state indication and so on for inter-cell mobility scenario since the legacy application time may not be enough to switch an information from serving cell to target cell, including a reference to determine the information application time or a time gap that is the duration from a communication device receives an information or transmits acknowledge information corresponding to an information in explicitly or implicitly way to the communication device starts to apply the information. In some embodiments, the time gap or duration can be also replaced with the minimum time gap or duration. or the time gap or duration can be first symbol or slot or subframe or frame that is at least the minimum time gap or duration after the reference. This patent document provides some feasible solutions to at least the issue(s) mentioned above.

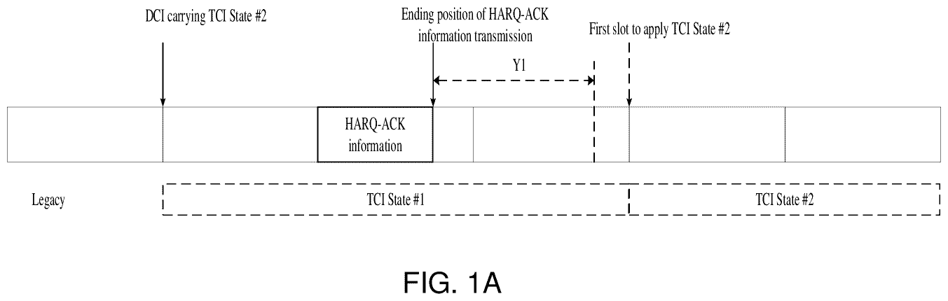

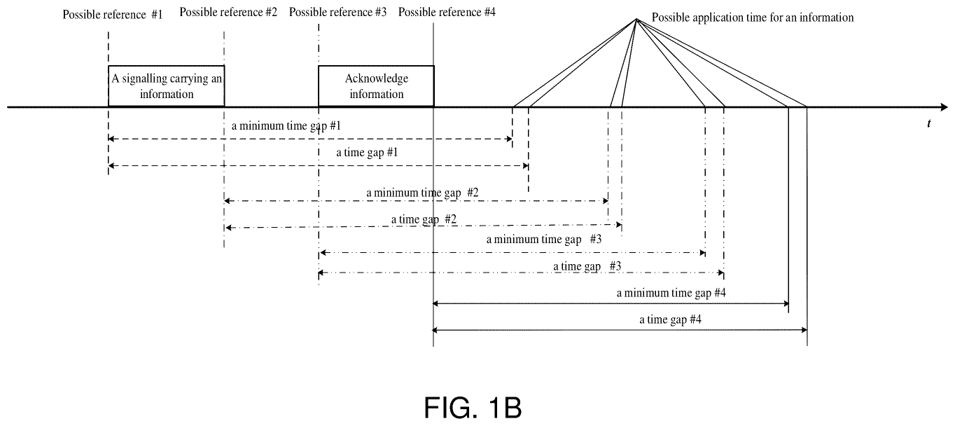

In some embodiments, the term “application time” of beam indication can be described as time for a user equipment (UE) to apply the indicated beam, where the time starts from a first slot that is at least BeamAppTime_r17 symbols after a reception of the last symbol of a physical uplink control channel (PUCCH) or a physical uplink shared channel (PUSCH) as shown in FIG. 1A. Hybrid automatic repeat request acknowledgement (HARQ-ACK) information corresponding to the downlink control information (DCI) carrying the TCI State indication without downlink (DL) assignment can be transmitted on the PUCCH or PUSCH; or HARQ-ACK information corresponding to the physical downlink shared channel (PDSCH) scheduling by the DCI carrying the TCI State indication can be transmitted on the PUSCH. The above mentioned HARQ-ACK information corresponding to the DCI carrying the TCI State indication without DL assignment or the PDSCH scheduling by the DCI carrying the TCI State indication is transmitted to the serving cell. BeamAppTime_r17 can be one of 1, 2, 4, 7, 14, 28, 42, 56, 70, 84, 98, 112, 224, 336 symbols.

FIG. 1A shows an example of application time for TCI state indication according to some embodiments. Here, horizontal axis represents time. As depicted, while TCI State 1 is applied, a DCI carrying TCI State 2 is received. Some time later, HARQ-ACK information is received. After Y1 time after the ending of the position of HARQ-ACK information transmission, in the subsequent slot, TCI state 2 is applied.

In some embodiments, the term “application time” of the indicated mapping between TCI states and codepoints of the DCI field ‘Transmission Configuration Indication’ can be described as follows: when the UE can transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ} + \frac{{2}^{μ}}{{2}^{{μ}_{K}} mac} \cdot {k}_{mac}$$

where μis the subcarrier spacing (SCS) configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the control resource set (CORESET) scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the demodulation reference signal (DM-RS) ports of PDSCH of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD’.

However, in Release 18, for some subjects, such as L1/L2 mobility enhancement, or multi-panel, or multi-TRP (transmission-reception point), or carrier aggregation (CA) scenarios, it may be helpful to consider one or more of the description of application time of an information or the description of a reference to an information application time or a time gap or a set of time gap to determine an information application time.

In some embodiments, a signaling may be received by a communication device. Information included in the signaling may include one or more of: transmission configuration indication (TCI) state, beam indication, switching command, cell identifier (ID), bandwidth part (BWP) ID, cell radio network temporary identifier (C-RNTI), random access procedure related information, cell switching indication, a timing advance (TA), a timing difference between serving cell and target cell, an association between a reference signal and a cell, a timer, an indication related to common information to be used for the target cell or a candidate cell, a channel/signal transmission or reception, reference signal, measurement configuration, report configuration.

In various embodiments, any one or more of the information can be indicated or activated or deactivated or updated by any one or more of medium access control element (MAC CE) signaling, DCI signaling, RRC signaling, or can be pre-defined.

In some embodiments, switching command can be or includes any one or more of TCI state indication, beam indication, indication of triggering random access channel RACH, timing advance, timing difference between serving cell and target cell, timer, the signaling carrying any one or more of above.

In different embodiments, a communication device can be a user equipment or base station.

FIG. 1B shows multiple examples of application times for a communication device to apply an information for L1/L2 mobility scenario. In order to define an application time, one or more of the following may be considered: a reference to determine the application time of an information, a time gap that is the duration from a communication device receives an information or transmits acknowledge information corresponding to an information in explicitly or implicitly way to the communication device starts to apply the information. In FIG. 1B, horizontal axis represents time.

The TCI state indication and/or beam indication can enable the UE to achieve mobility. The TCI state indication can indicate to the UE that the UE can switch from communicating with a source cell to communicating with a target cell. The TCI state indication includes source reference signal (RS), where the source RS is associated with a target cell. If the UE receives the TCI state indication, the UE can determine that it can transmit or receive with a target cell.

The beam indication can identify to the user equipment (UE) to use one or more beams for performing transmitting or receiving operation with a target cell.

In some embodiments, the switching command can indicate to the UE to: (1) switch from communicating with a source cell to communicating with a target cell, (2) perform a random access channel (RACH) procedure with a target cell, and/or (3) a timing advance value for the target cell.

### I. Example Embodiment 1

Embodiment 1 describes example methods to determine or describe a time gap or a minimum time gap to determine the time for applying an information. Optionally, a time gap or a minimum time gap can be different from the legacy time gap or BeamAppTime-r17 specified in Release 17. Note that a time gap or a minimum time gap can be replaced with a time duration or a minimum time duration.

In a specific scenario, if multiple time gap values or minimum time gap values to apply for an information are supported, then the different time gap values or minimum time gap values are applied based on UE capability.

In some embodiment, taking an information (e.g., one or more TCI state indication or TCI state update, switching command) as an example to illustrate how to determine or describe a time gap or a minimum time gap to determine the application time for an information. Note that the related method or rule can be also applied for other possible scenarios and/or other information.

In some embodiment, a time gap or a minimum time gap value can be determined by any one or more of the following:
Option-1: introduce new time gap (new with respect to legacy protocols) or a minimum time gap value; wherein, it is an individual one rather than the legacy time gap or BeamAppTime-r17 specified in Rel-17. In different embodiments, new time gap or a minimum time gap value is determined by UE capability, or configured by any one or more of RRC signaling, MAC CE signaling, DCI signaling, pre-defined.
Option-2: the new time gap or a minimum time gap value is determined by reusing any one or more of the minimum time values specified in Release 17;
Option-3: the new time gap or a minimum time gap is determined by extending the value range of the legacy minimum time. That is, some embodiments may introduce one or more additional time gap value on top of any one or more of minimum time value(s) specified in Release 17. Optionally, additional value is to better facilitate application of an information for candidate cell or target cell;
Option-4: the new time gap or a minimum time gap value is determined by any one or more of the minimum time value specified in Release 17 plus and/or minus and/or times and/or divided by an offset value or a set of offset value;
Option-5: the new time gap or a minimum time gap value is determined by any one or more of the minimum time values specified in Release 17 scaled by a scale factor. In some embodiments, scale factor is determined based on the SCS difference between source cell and target cell or pre-defined;
Option-6: the new time gap or a minimum time gap value is determined by any one or more of the minimum time values specified in Release 17 scaled by a scale factor plus and/or minus and/or times and/or divided by an offset value or a set of offset values;
Option-7: the new time gap or a minimum time gap value is determined by any one or more of minimum time value specified in Release 17 scaled by a scale factor plus and/or minus and/or times and/or divided by a timing difference;
Option-8: the new time gap or a minimum time gap value is determined by any one or more of minimum time value specified in Release 17 plus and/or minus and/or times and/or divided by a timing difference;
Option-9: the new time gap or a minimum time gap value is determined by any one or more of minimum value specified in Release 17 scaled by a scale factor plus and/or minus and/or times and/or divided by timing difference plus and/or minus and/or times and/or divided by an offset value or a set of offset values.

In some embodiment, the unit of the minimum time value specified in Release 17 mentioned above can be replaced with symbol, slot, subframe, frame, nanosecond, microsecond, millisecond, or second.

The minimum time value specified in Release 17 mentioned above can be one of 1, 2, 4, 7, 14, 28, 42, 56, 70, 84, 98, 112, 224, 336 symbols. The time duration value specified in Release 17 is first slot that is at least the minimum time value after a reference.

Optionally, the new time duration can be first symbol or slot or subframe or frame that is at least the new minimum time gap value after a reference. Optionally, the unit of the new minimum time gap value can be symbol, slot, subframe, frame, nanosecond, microsecond, millisecond, or second.

The timing difference mentioned above is a timing offset value between the serving cell and a target cell.

In some embodiment, the above-mentioned minimum time value specified in Release 17 scaled by a scale factor or minimum time value specified in Release 17 can be replaced by the minimum time value for scenario without taking SCS difference and/or timing difference between serving cell and target cell.

In some embodiment, the unit of offset value or timing difference can be any one or more of symbol, slot, subframe, frame, nanosecond, microsecond, millisecond, second.

In some embodiment, any one or more of the timing differences, offset can be determined by any one or more of pre-defined, network indication, RRC signaling, MAC CE signaling, DCI signaling, based on L1 measurement.

In some embodiment, the time gap or the minimum time gap value can be applied based on the SCS of serving cell or target cell.

### II. Example Embodiment 2

Embodiment 2 describes example methods to define a reference for determining the time for applying an information. E.g., any one or more of TCI state indication or beam indication or TCI state update or switching command.

In Release 17, the reference to determine application time of TCI state indication is the last symbol of the acknowledgement of the DCI carrying the TCI state indication or PDSCH scheduled by DCI carrying the TCI state indication.

In order to support cell switching or beam switching from a cell (or serving cell) to another cell (or target cell) or other scenarios, a reference to determine application time for an information needs to be described or clarified.

In some embodiment, a reference to determine application time for an information can be any one or more of the following alternatives:
Alternative-1: the first symbol in which an information or a signaling carrying an information is transmitted or received;
Alternative-2: the last symbol in which an information or a signaling carrying an information is transmitted or received;
Alternative-3: the starting of slot in which an information or a signaling carrying an information is transmitted or received;
Alternative-4: the ending of slot in which an information or a signaling carrying an information is transmitted or received;

In some embodiments, performing a communication may bean that a signaling is either transmitted or received by a base station or a UE.
Alternative-5: the first symbol in which acknowledge information corresponding to an information or a signaling carrying an information is transmitted or received to start;
Alternative-6: the last symbol in which acknowledge information corresponding to an information or a signaling carrying an information is transmitted or received to end;
Alternative-7: the starting of slot in which acknowledge information corresponding to an information or a signaling carrying an information is transmitted or received to start;
Alternative-8: the ending of slot in which acknowledge information corresponding to an information or a signaling carrying an information is transmitted or received to end;
Alternative-9: the first symbol in which acknowledge information corresponding to an information or a signaling carrying an information is transmitted or received to start. Optionally, the first symbol to transmit or receive the acknowledge information is determined based on the SCS of source cell;
Alternative-10: the last symbol in which acknowledge information corresponding to an information or a signaling carrying an information is transmitted or received to end. In some embodiments, the last symbol to transmit or receive the acknowledge information is determined based on the SCS of source cell;
Alternative-11: the starting of slot in which acknowledge information corresponding to an information or a signaling carrying an information is transmitted or received to start. In some embodiments, the starting of slot to transmit or receive the acknowledge information is determined based on the SCS of source cell;
Alternative-12: the ending of slot in which acknowledge information corresponding to an information or a signaling carrying an information is transmitted or received to end. In some embodiments, the ending of slot to transmit or receive the acknowledge information is determined based on the SCS of source cell;
Alternative-13: the first symbol in which acknowledge information corresponding to an information or a signaling carrying an information is transmitted or received to start. In some embodiments, the first symbol to transmit or receive the acknowledge information is determined based on the SCS of target cell;
Alternative-14: the last symbol in which acknowledge information corresponding to an information or a signaling carrying an information is transmitted or received to end. In some embodiments, the last symbol to transmit or receive the acknowledge information is determined based on the SCS of target cell;
Alternative-15: the starting of slot in which acknowledge information corresponding to an information or a signaling carrying an information is transmitted or received to start. In some embodiments, the starting of slot to transmit or receive the acknowledge information is determined based on the SCS of source cell target cell;

Alternative-16: the ending of slot in which acknowledge information corresponding to an information or a signaling carrying an information is transmitted or received to end. In some embodiments, the ending of slot to transmit or receive the acknowledge information is determined based on the SCS of target cell;

In some embodiments, if the acknowledge corresponding to an information or a signaling carrying an information is transmitted to source cell, then location of acknowledge corresponding to an information or a signaling carrying an information is determined by an offset value after the starting or ending of slot to receive an information or a signaling carrying an information from source cell. In some embodiments, the offset value is determined based on the SCS of serving cell.

However, if the acknowledge corresponding to an information or a signaling carrying an information is transmitted to target cell, then location of acknowledge corresponding to an information or a signaling carrying an information is determined by an offset value after the starting or ending slot to receive an information or a signaling carrying an information from target cell or source cell. Wherein, the offset value is determined based on the SCS of target cell.

The offset value mentioned above can be determined by any one or more of MAC CE signaling, DCI signaling, RRC signaling, pre-defined, an offset from source cell with a scale factor.

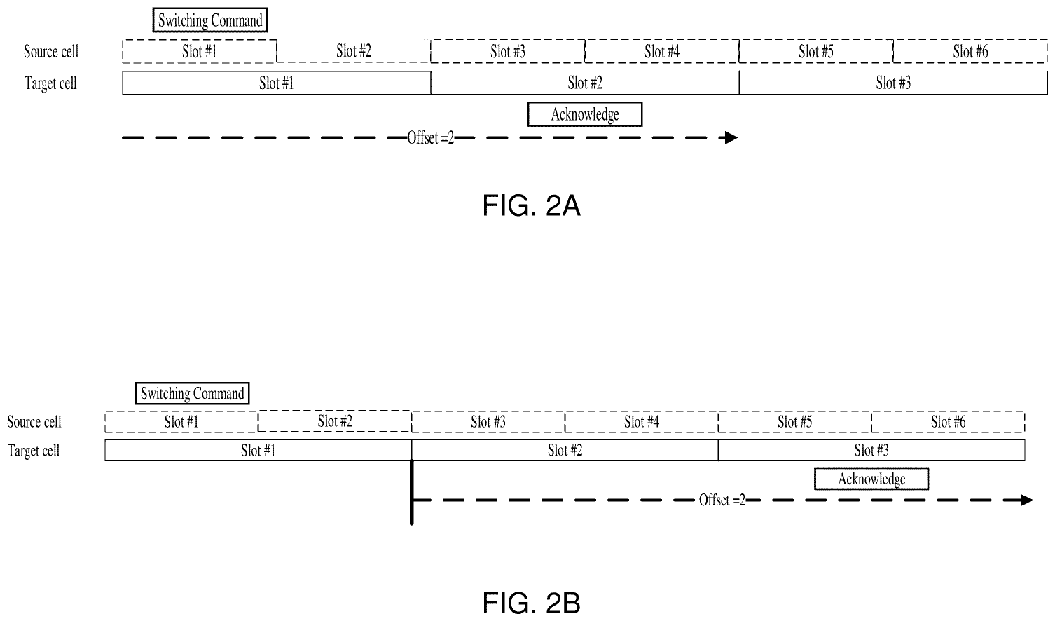

FIG. 2A shows a location of acknowledge corresponding to an information or a signaling carrying an information that is determined by an offset value after a starting of a slot where an information or a signaling carrying an information is received from target cell. In FIG. 2A, horizontal axis represents time.

FIG. 2B shows a location of acknowledge corresponding to an information or a signaling carrying an information that is determined by an offset value after the ending of slot where an information or a signaling carrying an information is received from target cell. In FIG. 2B, horizontal axis represents time.
Alternative-17: the first symbol in which acknowledge information corresponding to an information or a signaling carrying an information is transmitted or received to start. In some embodiments, the first symbol to transmit or receive the acknowledge is determined based on the SCS of target cell and the timing difference between source cell and target cell;
Alternative-18: the last symbol in which acknowledge information corresponding to an information or a signaling carrying an information is transmitted or received to end. In some embodiments, the last symbol to transmit or receive the acknowledge is determined based on the SCS of target cell and the timing difference between source cell and target cell;
Alternative-19: the starting of slot in which acknowledge information corresponding to an information or a signaling carrying an information is transmitted or received to start. In some embodiments, the starting of slot to transmit or receive the acknowledge is determined based on the SCS of target cell and the timing difference between source cell and target cell;
Alternative-20: the ending of slot in which acknowledge information corresponding to an information or a signaling carrying an information is transmitted or received to start. In some embodiments, the ending of slot to transmit or receive the acknowledge is determined based on the SCS of target cell and the timing difference between source cell and target cell;

In some embodiment, except that acknowledge information corresponding to an information or a signaling carrying an information is transmitted, acknowledge information can be some implicit information, such as channel/signal transmission or reception, MSG1 transmission, a MSG3 transmission, a MSG A transmission, or an RS transmission.
Alternative-21: the first symbol in which RS that is transmitted to source cell and/or target cell to let base station or network know timing advance (TA) information. Optionally, the transmission of RS can be seen as the acknowledge of an information or a signaling carrying an information;
Alternative-22: the last symbol in which RS that is transmitted to source cell and/or target cell to let base station or network know TA information. In some embodiments, the transmission of RS can be seen as the acknowledge of an information or a signaling carrying an information;
Alternative-23: the starting of slot in which RS is transmitted to source cell and/or target cell to let base station or network know TA information. In some embodiments, the transmission of RS can be seen as the acknowledge of an information or a signaling carrying an information;
Alternative-24: the starting of slot in which RS is transmitted to source cell and/or target cell to let base station or network know TA information. In some embodiments, the transmission of RS can be seen as the acknowledge of an information or a signaling carrying an information;

In some embodiment, the mentioned above RS can be replaced by MSG1, MSG3, MSG A. Wherein, RS can be any one or more of sounding reference signal SRS, DMRS, SSB, channel state information reference signal CSI-RS. In some embodiment, the rule or logic or method mentioned in any one or more of alternative-1 to 20 can be also applied for the case that acknowledge is RS, MSG1, MSG3 or MSG A.

### III. Example Embodiment 3

Embodiment 3 describes example methods to determine application time of an information indicated or activated by MAC CE signaling.

If MAC CE activates or indicates or updates an information or if a communication device receives an information indicated or activated or updated by MAC CE signalling in slot #n, then an information can be applied starting or ending from the first slot or symbol that is at least the minimum time gap or time gap after a reference.

(1) A reference can be defined as any one or more of:
Scheme-1: the starting of slot in which MAC CE is received by a communication device;
Scheme-2: the ending of slot in which MAC is received by a communication device;
Scheme-3: the first symbol in which MAC CE is received by a communication device;
Scheme-4: the end symbol in which MAC CE is received by a communication device;
Scheme-5: the starting of slot #m in which acknowledge information corresponding to MAC CE signaling or the PDSCH carrying the MAC CE signaling is transmitted by a communication device;
Scheme-6: the ending of slot #m in which acknowledge information corresponding to the PDSCH carrying the MAC CE signaling is transmitted by a communication device;
Scheme-7: the first symbol of acknowledge information corresponding to the PDSCH carrying the MAC CE signaling is transmitted by a communication device;
Scheme-8: the last symbol of acknowledge information corresponding to the PDSCH carrying the MAC CE signaling is transmitted by a communication device;
Any one or more of the rules or logic or methods mentioned in embodiment 2 or other embodiment can be also applied for the definition or determination of A reference.
   (2) A time gap or a minimum time gap can be defined or determined by any one or more of:
Method-1: analogous to Rel-15/16, a time gap or a minimum time gap value can be determined by X times N1 or defined as X times N1.
Method-2: a time gap or a minimum time gap value can be determined by T1 or defined as T1.
Method-3: a time gap or a minimum time gap value can be determined by X times N1 plus and/or minus and/or times and/or divided by an offset, or defined as X times N1 plus and/or minus and/or times and/or divided by an offset.
Method-4: a time gap or a minimum time gap value can be determined by at least one of P1 and P2.
Wherein, the unit of N1 or X or T1 or P1 or P2 or an offset can be subframe, slot, symbol, frame, nanosecond, microsecond, millisecond, or second;
Wherein, N1 or X or T1 or P1 or P2 or an offset can be an integer greater than or equal to a specific value. Optionally, a specific value is 0,1,2,3,4,5,6,7,8,9,10 and so on. Optionally, a specific value can be a fix value or a configurable value.
Wherein, N1 or X or T1 or P1 or P2 or an offset can be determined based on UE capability.
Wherein, N1 or X or T1 or P1 or P2 or an offset can be pre-defined or fixed, or configurable by any one or more of DCI signaling, MAC CE signaling, RRC signaling.

In some embodiment, any one or more of the rules or logic or methods mentioned in embodiment 1 or other embodiment can be also applied for the definition or determination of a time gap or a minimum time gap.

### IV. Example Embodiment 4

Embodiment 4 describes another example method to determine the beam of the first transmission to or receiving from target cell.

(1) If the offset between the reception of an information indicated or triggered or updated by a signaling and the first transmission to or receiving from target cell, or if the offset between the reception of a signaling indicating or triggering or updating an information and the first transmission to or receiving from target cell, or if the offset between the transmission of the acknowledge information corresponding to an information or a signaling carrying an information and the first transmission to or receiving from target cell is smaller than or equal to a threshold a communication device can apply default beam to receive/transmit the first transmission from/to target cell. In some embodiments, any one or more of TCI state indication or beam indication, switching command can be included in the information.
Wherein, the default beam means that a communication device may assume that RS of first transmission or reception to or from target cell are quasi co-located with RS with respect to QCL used or included for the information in the latest slot. Or, a beam of receiving or transmitting switching command or TCI state indication or beam indication or one or more RS used for DL sync, or signaling related physical random access channel PRACH; or the default beam is a beam to receive/transmit the first transmission from/to target cell associated with a beam of receiving or transmitting an information such as switching command or TCI state indication or beam indication and so on. In some embodiments, an association relationship or mapping between receiving or transmitting beam from serving cell and receiving or transmitting beam from target cell can be introduced or defined by any one or more of predefined or RRC signaling, or, MAC CE signaling, or DCI signaling.
   (2) If the offset between the reception of an information indicated or triggered or updated by a signaling and the first transmission to or receiving from target cell , or if the offset between the reception of a signaling indicating or triggering or updating an information and the first transmission to or receiving from target cell, or if the offset between the transmission of the acknowledge information corresponding to an information or a signaling carrying an information and the first transmission to or receiving from target cell is greater than or equal to a threshold, UE can apply the TCI state indication or beam indication indicated or triggered or updated by a signaling to receive/transmit the first transmission from/to target cell; optionally, any one or more of TCI state indication or beam indication or switching command can be included in the information.
   (3) If the offset between the reception of an information indicated or triggered or updated by a signaling and the first transmission to or receiving from target cell , or if the offset between the reception of a signaling indicating or triggering or updating an information and the first transmission to or receiving from target cell, or if the offset between the transmission of the acknowledge information corresponding to an information or a signaling carrying an information and the first transmission to or receiving from target cell is greater than or equal to a threshold, but switching command or an information indicated or triggered or updated by a signaling does not include TCI state indication or beam indication, UE can apply default beam to receive/transmit the first transmission from/to target cell.
In some embodiments, the default beam means that a communication device may assume that RS of first transmission or reception to or from target cell are quasi co-located with RS with respect to QCL used or included for the information in the latest slot. Or, the default beam is a beam of receiving or transmitting an information such as switching command or one or more RS used for DL sync, or signaling related PRACH and so on; or the default beam is a beam to receive/transmit the first transmission from/to target cell associated with a beam of receiving or transmitting an information such as switching command or TCI state indication or beam indication and so on. In some embodiments, an association relationship or mapping between receiving or transmitting beam from serving cell and receiving or transmitting beam from target cell can be introduced or defined by any one or more of predefined or RRC signaling, or, MAC CE signaling, or DCI signaling.

In some embodiment, the threshold mentioned above can be described based on any one or more of pre-defined, RRC signaling, MAC CE signaling, DCI signaling, UE capability.

### V. Example Embodiment 5

Embodiment 5 describes another example method to determine the beam of the first transmission or reception to/from target cell in the asynchronization scenarios between source cell and target cell.

Different from the previous some embodiment, this embodiment needs to consider timing difference between serving cell and target cell when determining a reference or the time gap or the minimum time gap value to apply TCI state indication or beam indication for the first transmission or reception to/from target cell or switching command. That is, the timing difference can be introduced in determining a reference or the time gap or the minimum time gap value to apply TCI state indication or beam indication for the first transmission or reception to/from target cell or switching command.

In some embodiment, the timing difference or the timing advance can be determined by any one or more of:
Alt-1: based on the network indication; wherein, the timing difference between serving cell (e.g., source cell) and target cell can be indicated by network;
Alt-2: the timing difference between serving cell (e.g., source cell) and target cell can be determined based on TA from serving cell minus TA from target cell. Wherein, TA from target cell can be indicated by network;
Alt-3: based on the L1 measurement;
Alt-4: based on the RACH procedure to obtain TA of target cell. Wherein, the timing difference is TA from serving cell (e.g., source cell) minus TA from target cell;
Alt-5: pre-defined.

### VI. Example Embodiment 6

Embodiment 6 describes another example method to determine the beam of the first transmission or receiving from target cell when source cell and target cell have different SCS.

Different from some of the previous embodiment, a scale factor is considered in this embodiment when describing a reference or the time gap or the minimum time gap value to apply an information such as TCI state indication or beam indication or switching command and so on, where a scale factor can be determined based on SCS of serving cell/SCS of target cell.

### VII. Example Embodiment 7

Embodiment 7 describes example methods to resolve an issue related to an entity (or network device or cell) to which the UE will send acknowledge information in an inter-cell mobility scenario.

Acknowledge information can be sent by UE to one of the following:
Alt-1: source cell;
Alt-2: target cell;
Alt-3: source cell and target cell.

In some embodiment, acknowledge information can be any one or more of: HARQ-ACK information corresponding to a signaling carrying an information, HARQ-ACK information corresponding to the PDSCH scheduling by a signaling carrying an information, HARQ-ACK information corresponding to an information indicated or triggered or updated by a signaling, MSG 1, MSG3, MSG A, RS, channel/signal.

In some embodiments, the above mentioned any one or more of a signaling carrying an information or an information indicated or triggered or updated by a signaling, MSG 1, MSG3, MSG A, RS, channel/signal is applied or used for target cell.

### VIII. Example Embodiment 8

Embodiment 8 describes another example method to determine the scenario in which application time of TCI state indication and/or switching command and/or other information for target cell can be used.

In some embodiment, different scenarios have different the description or definition of TCI state or switching command application time or the description or definition of a reference to determine TCI state and/or switching command application time or the time gap or the minimum time gap value or the minimum time gap value set. In some embodiment, a new RRC parameter can be used to indicate the usage of TCI state and/or switching command and/or other information application time.

In some embodiment, for a specific scenario such as L1/L2 mobility enhancement, multiple application time can be described or introduced. In some embodiments, different application time is applied for UE with different capability or different information for target cell. In some embodiments, one application time can be applied for any one or more of the information indicated or triggered or updated by a signaling for target cell.

### IX. Example Embodiment 9

In some embodiment, an information indicated or triggered or updated by any one or more signaling apply the same timeline or application time or effective time. In some embodiments, application time or timeline or effective time for an information can be determined based on legacy application time specified in Rel-17, or based on legacy application time specified in Rel-17 plus an offset, or a new time gap. In some embodiments, a reference to determine starting location of timeline or application time or time gap can reuse the legacy in Rel-17, or refer to any one or more of methods mentioned in embodiment 1 to 8. In some embodiments, a new time gap or a new minimum time gap can refer to any one or more of methods mentioned in embodiment 1 to 8.

In some embodiment, an information indicated or triggered or updated by a signaling can be applied starting from a first symbol or slot or subframe or frame that is a time gap or at least a minimum time gap after a reference. In some embodiments, an information includes cell switching command or indication and/or TCI state indication or beam indication. Once cell switching is completed, or cell switching command takes effect, the applicable definition or rule or application time of the beam indication or TCI state for the target cell or candidate cell can reuse the rule or definition specified in Rel-17; or the applicable definition or rule or application time of the beam indication or TCI state for the target cell or candidate cell can be determined based on a first symbol or slot or subframe or frame that is a time gap or at least a minimum time gap after cell switching is completed, or cell switching command takes effect; or application time of the beam indication or TCI state for the target cell or candidate cell is set to 0; or the beam indication or TCI state for the target cell or candidate cell takes effect or can be applied immediately; or the applicable definition or rule or application time of the beam indication or TCI state for the target cell or candidate cell can refer to any one or more of methods mentioned in embodiment 1 to 8.

In some embodiment, an information indicated or triggered or updated by a signaling can have same a reference to determine the time for applying the information; or, different information indicated or triggered or updated by a signaling can have different references to determine the time for applying the information.

In some embodiment, an information indicated or triggered or updated by a signaling can have same the time gap or the minimum time gap; or, different information indicated or triggered or updated by a signaling can have different time gaps or the minimum time gaps.

In some embodiment, for the case that an information indicated or triggered or updated by a signaling have same a reference and an information indicated or triggered or updated by a signaling have same the time gap or the minimum time gap, then an information can be applied starting from the first symbol or slot or subframe or frame that is a time gap or at least a minimum time gap after a reference.

In some embodiment, for the case that an information indicated or triggered or updated by a signaling have same a reference, but different information indicated or triggered or updated by a signaling have different time gaps or the minimum time gaps.

In some embodiment, for the case that the effective time or application time of different information is different, any one or more of the following solutions can be considered:
Solution-1: each information individually determines its own effective time or application time;
Solution-2: the effective time or application time for one or more information is determined based on the effective time or application time of switching indication or command.
   In some embodiments, switching indication or command is included in an information.
   In some embodiments, for an information that may be validated or applied before the effective time or application time of switching indication or command, whether at least one of these information is applied or validated based on any one or more of rules:
      rule-1: as long as the information that may be validated or applied before the effective time or application time of switching indication or command, any one or more of the information can be discarded or seen as invalidated or not applicable;
      rule-2: a timer is configured for the information that may be validated or applied before the effective time or application time of switching indication or command. In some embodiments, all information that may be validated or applied before the effective time or application time of switching indication or command have same timer. In some embodiments, different information that may be validated or applied before the effective time or application time of switching indication or command have different timers. If the timer expires before the effective time or application time of switching indication or command, then the information corresponding to the timer can be discarded or seen as invalidated or not applicable. If timer has not expired before the effective time or application time of switching indication or command, then the information can be applied or seen as validate or effective starting from the effective time or application time of switching indication. In some embodiments, the effective time or application time for the information that that may be validated or applied before the effective time or application time of switching indication or command can be set as 0. or the information can be applied or seen as validate or effective based on its own effective time or application time.
      Rule-3: an information that has taken effect before the switching indication or command takes effect remains effective. In some embodiments, once the switching indication or command takes effect, the information can be applied for first transmission or reception to/from target cell. In some embodiments, the information can be TCI state indication or beam indication.
   In some embodiments, for an information that will be validated or applied or take effect after the effective time or application time of switching indication or command, any one or more of the following methods can be considered:
      Method-1: an information that will be validated or applied or take effect after the switching indication or command takes effect or cell switching is completed can be applied after application time for the information;
      Method-2: an information that will be validated or applied or take effect after the switching indication or command takes effect or cell switching is completed can be immediately effective or applied;
      Method-3: application time or time gap of the information that may be effective or applied after the switching indication or command takes effect or cell switching is completed can be set to 0.
Solution-3: one or more information indicated or triggered or updated by any one or more signaling can be applied based on the maximum time gap or application time, or minimum time gap or application time, or the pre-defined time gap or application time, or the maximum UE capability, or minimum UE capability, or UE capability that is reported, or signaling indication.
All or part of method or solution mentioned above can be used independently or in combination.

In some embodiments, the information in the signaling includes a beam indication that identifies a beam for transmission or reception with the target cell, a transmission configuration indication (TCI) state indication that identifies a reference signal associated with the target cell, and/or a switching command that indicates to the communication to perform a handover between the source cell and the target cell.

### X. Example Systems and Apparatus

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in the various flowcharts, and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

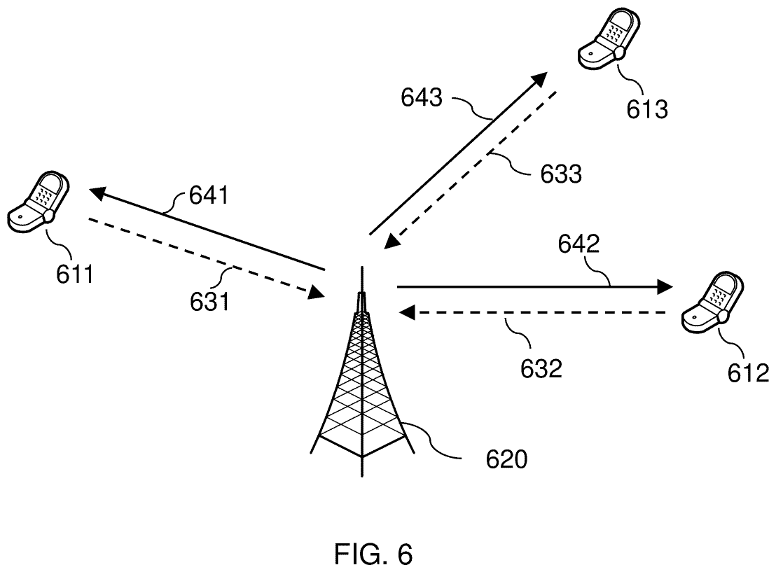

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

The following technical solutions may be adopted by some preferred embodiments.

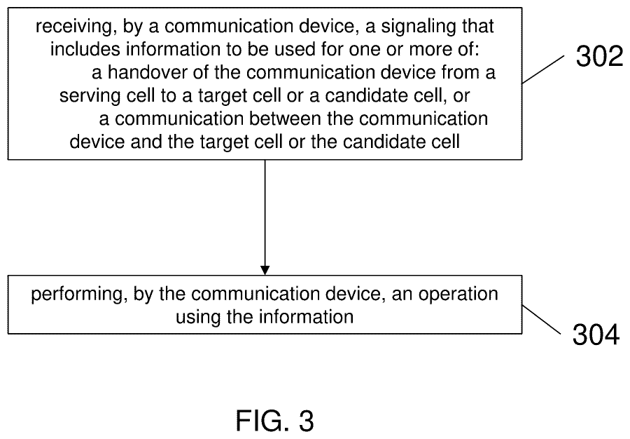

1. A wireless communication method (e.g., flowchart depicted in FIG. 3), comprising: receiving (302), by a communication device, a signaling that includes information to be used for one or more of: a handover of the communication device from a serving cell to a target cell or a candidate cell, or a communication between the communication device and the target cell or the candidate cell; and performing (304), by the communication device, an operation using the information.

2. The method of solution 1, wherein the performing the operation includes: applying the information starting from a specific time, or performing the communication using the information.

3. The method of any of solutions 1-2, wherein the signaling includes different information that is applied starting from different specific times, or wherein the signaling includes different information that is applied starting from a same specific time.

4. The method of solution 1, wherein, the information includes one or more of a cell switching indication and a transmission configuration indication (TCI) state and depending on the information received in the signaling, the operation comprises one or more of: applying the cell switching indication and the TCI state indication starting from the specific time; interpreting the TCI state indication to be the cell switching indication and applying the TCI state indication starting from the specific time; continuing to apply the TCI state indication after the applying the cell switching indication or completing cell switching; applying the TCI state indication simultaneously with the applying the cell switching indication; using a rule for determining a time at which the TCI state indication is applied after the applying the cell switching indication or the completing the cell switching; setting a time gap to apply the TCI state to 0 after the applying the cell switching indication or the completing the cell switching; applying the TCI state indication at a specific time after the applying the cell switching indication or the completing the cell switching; applying the TCI state indication after a time gap after the applying the cell switching indication or the completing the cell switching; using a rule to determine a time of use of the TCI state indication due to receiving the TCI state indication after the applying the cell switching indication or the completing the cell switching; using the TCI state indication at another specific time due to receiving the TCI state indication after the applying the cell switching indication or the completing the cell switching.

5. The method of any one of solutions 1 to 3, wherein the specific time is when a first information included in the signaling is applied, wherein a second time is when a second information included in the signaling is applied, wherein the communication device performs any one or more of the following in response to the specific time being later than the second time: continue applying the second information; determine that the second information is invalid; determine that the second information cannot be applied; apply the second information after the specific time; apply the second information at a time in which the first information is applied; or set a time when the second information is applied as zero.

6. The method of any one of solutions 1 to 4, wherein the communication device performs any one or more of the following in response to the communication device receiving a second information after a specific time when a first information is applied: determining a second time when the second information is applied based on an existing rule; determining the second time when the second information is applied based on a time gap relative to the specific time when the first information indicated or updated by the signaling is applied; determining the second time when the second information is applied based on a time gap relative to a reference point; or determining that the second information is not to be received within a time gap after the specific time when the first information indicated or updated by the signaling is applied.

7. The method of any one of solutions 1 to 4, further comprising determining, by the communication device, not to receive the second information indicated or updated by the signaling before the specific time when the first information indicated or updated by the signaling is applied; or determining, by the communication device, that the second information is invalid in response to the communication device receiving the second information indicated or updated by the signaling before the specific time when the first information indicated or updated by the signaling is applied; or discarding the second information in response to the communication device receiving the second information indicated or updated by the signaling before the specific time when the first information indicated or updated by the signaling is applicd.

8. The method of any one of solutions 1 to 7, wherein the specific time is determined by a time gap relative to a reference.

9. The method of any one of solution 1, 6 or 8, wherein the signaling includes different information that has different reference points, or wherein the signaling includes different information that has a same reference point.

10. The method of solution 8 or 9, wherein the reference point includes any one or more of the following: a start position or an end position when the communication device receives the signaling that indicates or updates the information; a start position or an end position when the communication device receives the information indicated or updated by the signaling, a start position or an end position when the communication device transmits an acknowledge information in response to the signaling that indicates or updates the information, or a start position or an end position when the communication device transmits the acknowledge information in response to the information indicated or updated by the signaling.

11. The method of solution 10, wherein the start position or the end position includes a start or an end of time slot or a start or an end of a symbol.

12. The method of any one of solutions 1 to 11, further comprising any one or more of the following: wherein the reference point is determined based on a first sub-carrier spacing (SCS) of the source cell or a second SCS of the target cell in response to the first SCS being different from the second SCS; or wherein the reference point is determined considering any one or more of a timing difference between the source cell and the target cell, a first timing advance (TA) of the source cell, or a second TA of the target cell in response to the source cell being non-synchronized with the target cell.

13. The method of solution 4, 6, or 8, wherein the time gap is a duration that include a minimum value of the time gap; or wherein the time gap is a duration in a time domain.

14. The method of solution 4, 6 or 8, wherein the time gap or a minimum value of the time gap is determined based on any one or more of: at least one current value; one or more additional values is added on top of at least one value from a current value set; at least one current value plus a specific value or a set of specific values; at least one current value scaled by a scaling factor; a radio resource control (RRC) signaling configuration; media access control-control element (MAC CE) signaling indication; a downlink control information (DCI) signaling indication; a pre-defined value; a capability of the communication device; a value obtained from X*N1; a value obtained from X*N1 and an offset; a value of the variable T1; or any one or more of P1 and P2.

15. The method of any one of solutions 4 to 14, wherein a granularity of the time gap or of the time gap is a symbol, a slot, a subframe, a frame, nanosecond, microsecond, millisecond, or second.

16. The method of any one of solutions 1 to 15, wherein the signaling includes a downlink control information (DCI) or a media access control-control element (MAC CE).

17. The method of solution 10, wherein the acknowledge information is transmitted by the communication device to any one or more of the source cell or the target cell.

18. The method of solution 1, further including: using the information received from the serving cell for the communication with the target cell or the candidate cell.

19. The method of solution 18, wherein the using depends on an association between the information received from the serving cell and information from the target cell or the candidate cell.

20. The method of any of solutions 1 to 19, wherein the information includes any one or more of the following: a transmission configuration indication (TCI) state, a beam indication, a switching command, a cell identifier (ID), a bandwidth part (BWP) ID, a cell radio network temporary identifier (C-RNTI), a random access procedure related information, a cell switching indication, a timing advance (TA), a timing difference between serving cell and target cell, an association between a reference signal and a cell, a timer, an indication related to common information to be used for the target cell or a candidate cell, a channel/signal transmission or reception, reference signal.

21. The method of solution 1 or 20, comprising: enabling or activating a first parameter of the target cell or the candidate cell after the applying the switching or completing the switching; or using or activating a second parameter of the target cell or the candidate cell after the receiving the switching command or the cell switching indication.

22. The method of solution 20, a timing advance (TA) or a timing difference is obtained by any one or more of: an indication from a network device; the timing difference is obtained based on a first TA value associated with the source cell minus a second TA value associated with the target cell; based on L1 measurement; based on a random access channel (RACH) procedure; or based on a pre-defined method.

23. The method of solution 14, wherein the unit of N1 or X or T1 or P1 or P2 or offset is a subframe, a slot, a symbol, a frame, a time unit measured in nanoseconds, microseconds, milliseconds, or seconds.

24. The method of solution 14, wherein N1 or X or T1 or P1 or P2 of offset is an integer larger than or equal to a specific value.

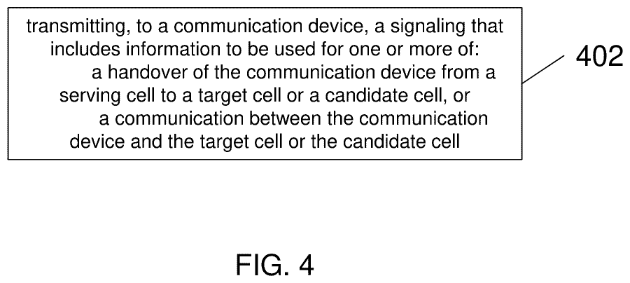

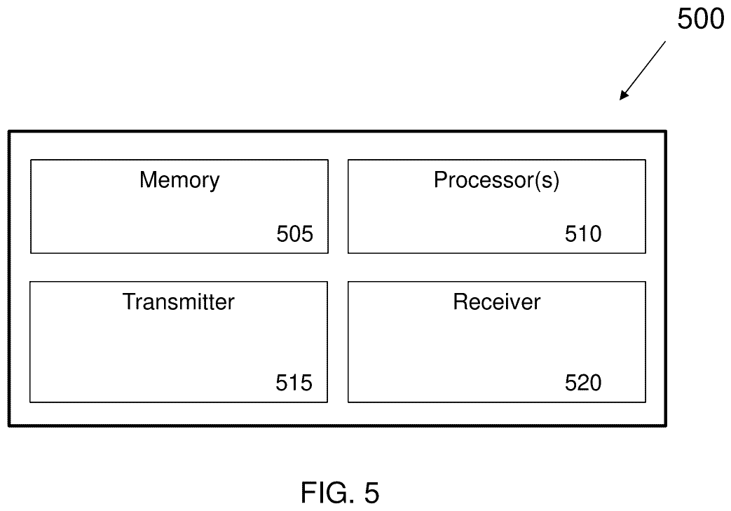

25. A wireless communication method (e.g., flowchart depicted in FIG. 4), comprising: transmitting (402), by a network device, a signaling that includes information to be used for one or more of: a handover of a communication device from a serving cell to a target cell or a candidate cell, or a communication between the communication device and the target cell or the candidate cell.

26. The method of solution 25, wherein the signaling causes the communication device to perform an operation includes: applying the information starting from a specific time, or performing the communication using the information.

27. The method of any of solutions 25-26, wherein the signaling includes different information that is applied starting from different specific times, or wherein the signaling includes different information that is applied starting from a same specific time.

28. The method of solution 25, wherein, the information includes one or more of a cell switching indication and a transmission configuration indication (TCI) state and depending on the information received in the signaling, the operation comprises one or more of: applying the cell switching indication and the TCI state indication starting from the specific time; interpreting the TCI state indication to be the cell switching indication and applying the TCI state indication starting from the specific time; continuing to apply the TCI state indication after the applying the cell switching indication or completing cell switching; applying the TCI state indication simultaneously with the applying the cell switching indication; using a rule for determining a time at which the TCI state indication is applied after the applying the cell switching indication or the completing the cell switching; setting a time gap to apply the TCI state to 0 after the applying the cell switching indication or the completing the cell switching; applying the TCI state indication at a specific time after the applying the cell switching indication or the completing the cell switching; applying the TCI state indication after a time gap after the applying the cell switching indication or the completing the cell switching; using a rule to determine a time of use of the TCI state indication due to receiving the TCI state indication after the applying the cell switching indication or the completing the cell switching; using the TCI state indication at another specific time due to receiving the TCI state indication after the applying the cell switching indication or the completing the cell switching.

29. The method of any one of solutions 25 to 27, wherein the specific time is when a first information included in the signaling is applied, wherein a second time is when a second information included in the signaling is applied, wherein the communication device performs any one or more of the following in response to the specific time being later than the second time: continue applying the second information; determine that the second information is invalid; determine that the second information cannot be applied; apply the second information after the specific time; apply the second information at a time in which the first information is applied; or set a time when the second information is applied as zero.

30. The method of any one of solutions 25 to 28, wherein the signaling causes the communication device to perform any one or more of the following in response to the communication device receiving a second information after a specific time when a first information is applied: determining a second time when the second information is applied based on an existing rule; determining the second time when the second information is applied based on a time gap relative to the specific time when the first information indicated or updated by the signaling is applied; determining the second time when the second information is applied based on a time gap relative to a reference point; or determining that the second information is not to be received within a time gap after the specific time when the first information indicated or updated by the signaling is applied.

31. The method of any one of solutions 25 to 28, wherein the signaling causes the communication device to: determine, by the communication device, not to receive the second information indicated or updated by the signaling before the specific time when the first information indicated or updated by the signaling is applied; or determine, by the communication device, that the second information is invalid in response to the communication device receiving the second information indicated or updated by the signaling before the specific time when the first information indicated or updated by the signaling is applied; or discard the second information in response to the communication device receiving the second information indicated or updated by the signaling before the specific time when the first information indicated or updated by the signaling is applied.

32. The method of any one of solutions 25 to 31, wherein the specific time is determined by a time gap relative to a reference.

33. The method of any one of solution 25, 30 or 32, wherein the signaling includes different information that has different reference points, or wherein the signaling includes different information that has a same reference point.

34. The method of solution 32 or 33, wherein the reference point includes any one or more of the following: a start position or an end position when the communication device receives the signaling that indicates or updates the information; a start position or an end position when the communication device receives the information indicated or updated by the signaling, a start position or an end position when the communication device transmits an acknowledge information in response to the signaling that indicates or updates the information, or a start position or an end position when the communication device transmits the acknowledge information in response to the information indicated or updated by the signaling.

35. The method of solution 34, wherein the start position or the end position includes a start or an end of time slot or a start or an end of a symbol.

36. The method of any one of solutions 25 to 35, further comprising any one or more of the following: wherein the reference point is determined based on a first sub-carrier spacing (SCS) of the source cell or a second SCS of the target cell in response to the first SCS being different from the second SCS; or wherein the reference point is determined considering any one or more of a timing difference between the source cell and the target cell, a first timing advance (TA) of the source cell, or a second TA of the target cell in response to the source cell being non-synchronized with the target cell.

37. The method of solution 28, 30, or 32, wherein the time gap is a duration that include a minimum value of the time gap; or wherein the time gap is a duration in a time domain.

38. The method of solution 28, 30, or 32, wherein the time gap or a minimum value of the time gap is determined based on any one or more of: at least one current value; one or more additional values is added on top of at least one value from a current value set; at least one current value plus a specific value or a set of specific values; at least one current value scaled by a scaling factor; a radio resource control (RRC) signaling configuration; media access control-control clement (MAC CE) signaling indication; a downlink control information (DCI) signaling indication; a pre-defined value; a capability of the communication device; a value obtained from X*N1; a value obtained from X*N1 and an offset; a value of the variable T1; or any one or more of P1 and P2.

39. The method of any one of solutions 28 to 38, wherein a granularity of the time gap or of the time gap is a symbol, a slot, a subframe, a frame, nanosecond, microsecond, millisecond, or second.

40. The method of any one of solutions 25 to 39, wherein the signaling includes a downlink control information (DCI) or a media access control-control element (MAC CE).

41. The method of solution 34, wherein the acknowledge information is transmitted by the communication device to any one or more of the source cell or the target cell.

42. The method of solution 25, further including: using the information received from the serving cell for the communication with the target cell or the candidate cell.

43. The method of solution 42, wherein the using depends on an association between the information received from the serving cell and information from the target cell or the candidate cell.

44. The method of any of solutions 25 to 43, wherein the information includes any one or more of the following: a transmission configuration indication (TCI) state, a beam indication, a switching command, a cell identifier (ID), a bandwidth part (BWP) ID, a cell radio network temporary identifier (C-RNTI), a random access procedure related information, a cell switching indication, a timing advance (TA), a timing difference between serving cell and target cell, an association between a reference signal and a cell, a timer, an indication related to common information to be used for the target cell or a candidate cell, a channel/signal transmission or reception, reference signal.

45. The method of solution 25 or 44, comprising: enabling or activating a first parameter of the target cell or the candidate cell after the applying the switching or completing the switching; or using or activating a second parameter of the target cell or the candidate cell after the receiving the switching command or the cell switching indication.

46. The method of solution 44, a timing advance (TA) or a timing difference is provided by any one or more of: an indication from the network device; the timing difference is obtained based on a first TA value associated with the source cell minus a second TA value associated with the target cell; based on L1 measurement; based on a random access channel (RACH) procedure; or based on a pre-defined method.

47. The method of solution 38, wherein the unit of N1 or X or T1 or P1 or P2 or offset is a subframe, a slot, a symbol, a frame, a time unit measured in nanoseconds, microseconds, milliseconds, or seconds.

48. The method of solution 38, wherein N1 or X or T1 or P1 or P2 of offset is an integer larger than or equal to a specific value.

49. An apparatus for wireless communication comprising a processor, configured to implement a method recited in one or more of solutions 1 to 48.

50. A non-transitory computer readable program storage medium having code stored thereon, the code, when executed by a processor, causing the processor to implement a method recited in one or more of solutions 1 to 48.

The above-described example embodiments 1 to 9 provide further details of the above-listed technical solutions. In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
receiving, by a communication device, a signaling that includes information including any one or more of the following: a transmission configuration indication (TCI) state, a beam indication, a switching command, a cell identifier (ID), a bandwidth part (BWP) ID, a cell radio network temporary identifier (C-RNTI), a random access procedure related information, a cell switching indication, a timing advance (TA), a timing difference between a serving cell and a target cell, an association between a reference signal and a cell, a timer, an indication related to common information to be used for the target cell or a candidate cell, a channel/signal transmission or reception, reference signal; and
performing, by the communication device, an operation using the information, and
wherein the performing of the operation includes:
performing a transmission or a reception for the target cell or the candidate cell using the information, or
applying the information starting from a specific time or simultaneously with applying of the cell switching indication.

2-7. (canceled)

8. The method of claim 1, wherein the specific time is determined by a time gap or a minimum value of the time gap relative to a reference point.

9. The method of claim 1, wherein the signaling includes different information that has different reference points or a same reference point.

10. The method of claim 9, wherein the reference point includes any one or more of the following:
a start position or an end position at which the communication device receives the signaling that indicates or updates the information;
a start position or an end position at which the communication device receives the information indicated or updated by the signaling, a start position or an end position at which the communication device transmits an acknowledge information corresponding to the signaling that indicates or updates the information, or
a start position or an end position at which the communication device transmits the acknowledge information corresponding to the information indicated or updated by the signaling.

11. (canceled)

12. The method of claim 8, further comprising any one or more of the following:
wherein the reference point is determined based on a first sub-carrier spacing (SCS) of a source cell or a second SCS of the target cell in response to the first SCS being different from the second SCS; or
wherein the reference point is determined considering any one or more of a timing difference between the source cell and the target cell, a first timing advance (TA) of the source cell, or a second TA of the target cell in response to the source cell being non-synchronized with the target cell.

13. (canceled)

14. The method of claim 8, wherein the time gap or the minimum value of the time gap is determined based on any one or more of:
at least one current value; one or more additional values is added on top of at least one value from a current value set; at least one current value plus a specific value or a set of specific values; at least one current value scaled by a scaling factor; a radio resource control (RRC) signaling configuration; media access control-control element (MAC CE) signaling indication; a downlink control information (DCI) signaling indication; a pre-defined value; a capability of the communication device; a value obtained from X*N1; a value obtained from X*N1 and an offset; a value of a variable T1; or any one or more of P1 and P2.

15. The method of claim 8, wherein a granularity of the time gap is a symbol, a slot, a subframe, a frame, nanosecond, microsecond, millisecond, or second.

16. The method of claim 1, wherein the signaling includes a downlink control information (DCI) or a media access control-control element (MAC CE).

17-21. (canceled)

22. The method of claim 1, wherein the timing advance (TA) or the timing difference is obtained by any one or more of:
an indication from a network device;
the timing difference is obtained based on a first TA value associated with a source cell minus a second TA value associated with the target cell;
based on L1 measurement;
based on a random access channel (RACH) procedure; or
based on a pre-defined method.

23-24. (canceled)

25. A wireless communication method, comprising:
transmitting, by a network device, a signaling that includes information including any one or more of the following: a transmission configuration indication (TCI) state, a beam indication, a switching command, a cell identifier (ID), a bandwidth part (BWP) ID, a cell radio network temporary identifier (C-RNTI), a random access procedure related information, a cell switching indication, a timing advance (TA), a timing difference between a serving cell and a target cell, an association between a reference signal and a cell, a timer, an indication related to common information to be used for the target cell or a candidate cell, a channel/signal transmission or reception, reference signal,
wherein the signaling causes the communication device to perform an operation that includes:
performing a transmission or a reception for the target cell or the candidate cell using the information, or
applying the information starting from a specific time or simultaneously with applying of the cell switching indication.

26-31. (canceled)

32. The method of claim 25, wherein the specific time is determined by a time gap or a minimum value of the time gap relative to a reference point.

33. The method of claim 25,
wherein the signaling includes different information that has different reference points or a same reference point.

34. The method of claim 33, wherein the reference point includes any one or more of the following:
a start position or an end position at which the communication device receives the signaling that indicates or updates the information;
a start position or an end position at which the communication device receives the information indicated or updated by the signaling, a start position or an end position at which the communication device transmits an acknowledge information corresponding to the signaling that indicates or updates the information, or a start position or an end position at which the communication device transmits the acknowledge information corresponding to the information indicated or updated by the signaling.

35. (canceled)

36. The method of claim 32, further comprising any one or more of the following:
wherein the reference point is determined based on a first sub-carrier spacing (SCS) of a source cell or a second SCS of the target cell in response to the first SCS being different from the second SCS; or
wherein the reference point is determined considering any one or more of a timing difference between the source cell and the target cell, a first timing advance (TA) of the source cell, or a second TA of the target cell in response to the source cell being non-synchronized with the target cell.

37. (canceled)

38. The method of claim 32, wherein the time gap or the minimum value of the time gap is determined based on any one or more of:
at least one current value; one or more additional values is added on top of at least one value from a current value set; at least one current value plus a specific value or a set of specific values; at least one current value scaled by a scaling factor; a radio resource control (RRC) signaling configuration; media access control-control element (MAC CE) signaling indication; a downlink control information (DCI) signaling indication; a pre-defined value; a capability of the communication device; a value obtained from X*N1; a value obtained from X*N1 and an offset; a value of a variable T1; or any one or more of P1 and P2.

39. The method of claim 32, wherein a granularity of the time gap is a symbol, a slot, a subframe, a frame, nanosecond, microsecond, millisecond, or second.

40. The method of claim 25, wherein the signaling includes a downlink control information (DCI) or a media access control-control element (MAC CE).

41-45. (canceled)

46. The method of claim 25, wherein the timing advance (TA) or the timing difference is provided by any one or more of:
an indication from the network device;
the timing difference is obtained based on a first TA value associated with a source cell minus a second TA value associated with the target cell;
based on L1 measurement;
based on a random access channel (RACH) procedure; or
based on a pre-defined method.

47-50. (canceled)

51. The method of claim 1, wherein the signaling includes different information that is applied starting from different specific times or a same specific time.

52. The method of claim 25, wherein the signaling includes different information that is applied starting from different specific times or a same specific time.
